(19) United States
(12) Patent Application Publication
(10) Pub. No.: US 2011/0246314 A1
(43) Pub. Date: Oct. 6, 2011

(54) Cash management system and method

(75) Inventors: Kent Dwight Bowden, Norman, OK (US); Michael Brent Carpenter, Blanchard, OK (US)

(73) Assignee: M3 Technology Solutions, LLC

(21) Appl. No.: 13/065,909

(22) Filed: Apr. 1, 2011

Related U.S. Application Data
(60) Provisional application No. 61/341,572, filed on Apr. 1, 2010.

(51) Int. Cl. G06Q 40/00; G06Q 10/00

(52) U.S. Cl. 705/16; 705/30

(57) ABSTRACT

The present invention relates to a new system and method for conducting business that provides a fully integrated cash management system for easily accessible, real-time cash flow figures for all vaults, sub vaults, banks, mini banks, point-of-sale (POS) stations, ticket redemption kiosks and automated teller machines (ATM) for casinos, gaming centers, and casino resorts. The invention may be utilized in multiple sites and utilized for resorts, retail in general, banks, stadiums, theme parks and so forth.

### CROSS-REFERENCE TO RELATED APPLICATIONS

Priority is claimed from provisional patent application U.S. Ser. No. 61/341,572, filed on Apr. 1, 2010 and incorporated by reference herein.

### BACKGROUND OF THE INVENTION

1. Field of the Invention

In general, the present invention relates to a new system and method for conducting business and operations involving voluminous cash flow and cash transactions. More specifically but not to be considered limiting, the present invention provides a system and method that provides a fully integrated cash management system, and more particularly, a fully integrated cash management computer system that provides easily accessible, real-time cash flow figures for all vaults, sub vaults, banks, mini banks, point-of-sale (POS) stations, ticket redemption kiosks, and automated teller machines (ATM) for casino resorts. It is further contemplated that the invention may be utilized in multiple sites located around the world and also utilized for resorts, retail in general, banks, stadiums, theme parks and other voluminous cash flow applications. Moreover, the electronic recording of each cash transaction allows for the invention to statistically determine the optimum operating capital for each individual function as well as for the entire enterprise. The invention analytics also allows for optimizing the placement and function of transactional employees.

2. Description of the Prior Art

Many casino resort operators use spreadsheets and manual processes to determine their critical cash positions. This cumbersome and inefficient process often results in several days delay between when funds are brought in and when they are actually realized by their current cash management solution. Idle cash on property costs money when not utilized to its potential. As many casino resort operators pull through the current recession, research shows that CFO's and GM's are looking more closely at cost saving solutions, including managing idle cash on property as well as more closely viewing all transactions.

Since the inception of casino gaming in the United States, companies such as WMS, Bally Technologies, and IGT have provided slot machines and slot management solutions. These companies have historically dominated the market; however, they still do not meet the current needs of the industry that desire casino resort management software solutions other than just a focus on slot machines.

The prior art does not currently provide the desired software and systems solutions. It is known that prior art applications have offered vault-type products focused on manual entry of accounting data to determine the current cash position, but this long process causes delays so that operators are unaware of the amount of cash sitting idle in ATMs, ticket redemption kiosks, banks, and mini-banks. By example, an operation with more than 13,000 slot machines on its properties may, each time an ATM kiosk or redemption was replenished, have to fill it to capacity of $80,000 without regard for how much was being used or sat idle in the machine.

The current industry is looking for a single cash management solution for integrated casino resort operations wherein a dashboard would allow executive management a full view of all financial activity on property in real-time. Furthermore, casino management would prefer to see in seconds the $1s, $5s, $10s and so on in the vaults, sub vaults, banks, mini-banks, POS stations (cashiers, restaurants, gift shops etc.), ticket redemption kiosks, and ATM's at any one of an operator's properties around the world.

What is needed today is to provide casinos, casino resorts, and gaming centers technology and applications that will solve or reduce day to day problems, effectively maximize cash control, reduce security risks, and automate key control processes where the prior art has failed or is deficient. Therefore a need and a desire exists to provide a means for providing a system and method that allows those involved with gaming to optimize cash management.

### SUMMARY OF THE INVENTION

In view of the foregoing disadvantages and limitations inherent in the known methods and systems now present in the prior art, the present invention provides a new and improved method and system wherein the same can be utilized in those situations where speed, cost, and ease of use are desired. As such, the general purpose of the present invention, which will be described subsequently in greater detail, is to provide a new and improved business and operations system or systems which allows real-time cash management including an analytic function such as but not limited to Smartware™ analytics by M3T, which has all the advantages of the prior art and none of the disadvantages.

To attain this, the present invention essentially comprises a method or a system that provides superior software, systems, and methods for cash management which utilizes a comprehensive system application. The current invention generally minimizes idle cash inventory and provides easy access to these funds for other applications, integrates all automated cash processing equipment and offers analytical reporting features and enhanced security, and further allows executive management to view all financial activity on property in real-time via a unique user interface or dashboard.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved cash management system and method, which may be easily and efficiently accessed, implemented, and utilized for voluminous cash flow and transactions such as but not limited casinos, resorts, retail in general, banks, stadiums, theme parks, casino resorts and other voluminous cash flow applications which may be utilized in numerous locations and globally.

It is a further object of the present invention to provide a new and improved casino cash management system and method which may be utilized at numerous locations including worldwide operations. As such, the present invention is compatible with current implementations, systems, and methods in the casino industry.

An even further object of the present invention is to provide a new and improved casino cash management system and method which is susceptible to a low cost of use with regard to both access and implementation, and which accordingly is then susceptible to low prices of use and sale to gaming centers, casinos, and or casino resort centers, thereby making such economically available to the same.

Still another object of the present invention is to provide a new and improved casino cash management system and method which provides all of the advantages of the prior art, while simultaneously overcoming some of the disadvantages normally associated therewith.

Another object of the present invention is to provide a new and improved casino cash management system and method which is of a durable, reliable, and fail safe implementation.

Yet another object of the present invention is to provide a new and improved casino cash management system and method that provides analytical reporting and or electronic audit and variance reporting features for enhanced security attributes leading to a reduction in theft by employees along with total integration of all automated cash processing equipment.

Still another object of the present invention is to provide a new and improved casino cash management system and method that generally minimizes idle cash inventory, provides easy access to funds for other applications, integrates all automated cash processing equipment, offers analytical reporting features, provides enhanced security, and further allows executive management to view all financial activity on property in real-time via a unique user interface or dashboard.

Another object of the present invention is to provide electronic “real-time” reporting and statistical calculations for the purpose of reducing and optimizing the use of transactional personnel.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, exhibits, screen captures, and appendices.

FIG. 1 is a general depiction of a preferred embodiment of the invention in a general flow chart depiction.

FIG. 2 is a general depiction of a preferred embodiment of the invention in a general flow chart depiction.

FIG. 3 is a general depiction of a preferred embodiment of the invention in a general flow chart depiction.

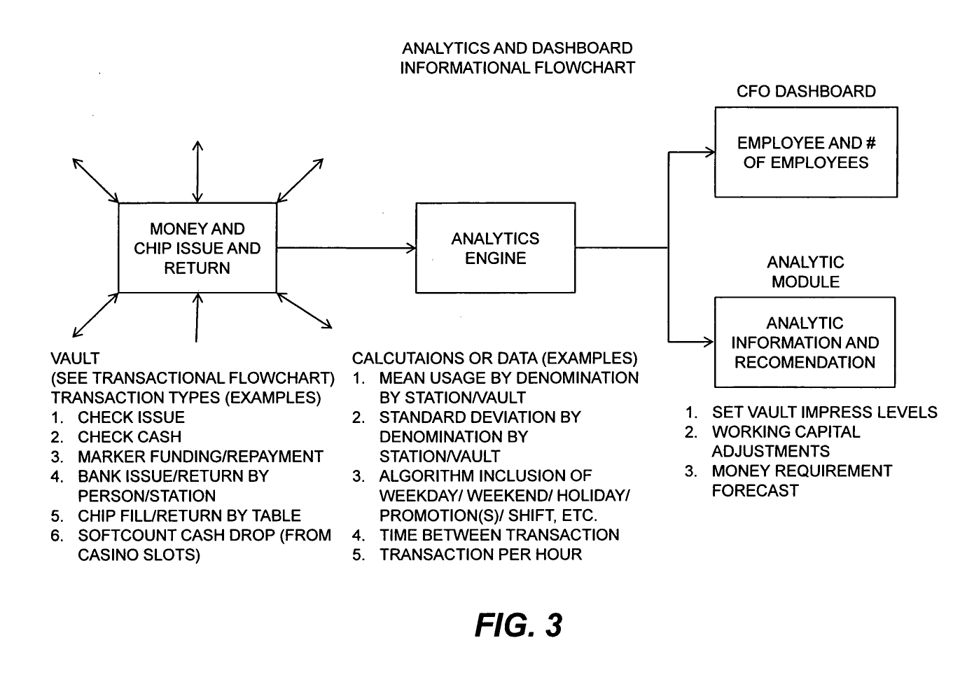

### DETAILED DESCRIPTION OF THE PREFERRED EMBODIMENTS

In a preferred embodiment, the invention may be a system, method, process, method of doing business, and or a computer program with the understanding it may also be combinations of the same. It is understood that the following is for purposes of illustration and should not be considered to limit the scope of the invention.

It is also understood that the current invention may be utilized for numerous applications and products other than specific gaming center operations. It may be utilized with other cash management systems in general as well as other types of products and services. Furthermore, the term “gaming” and or “casino” should not be considered limiting to the scope of the invention. Although the current invention has been developed specifically for casino centers, it is understood that other utilities and applications are contemplated.

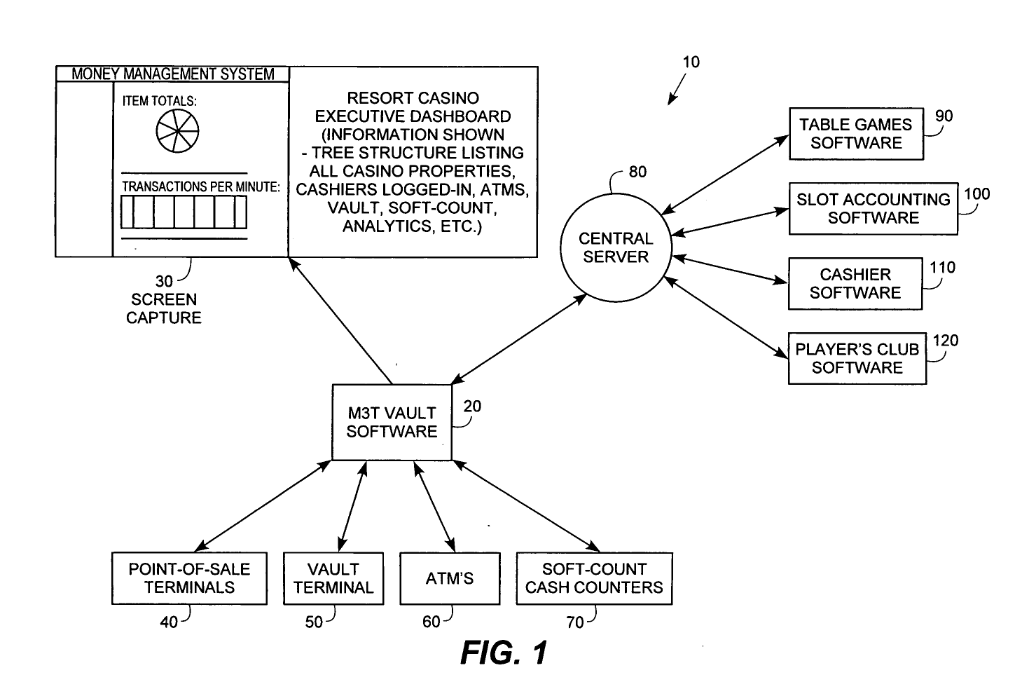

Now generally referring to the illustrations and more in particular FIG. 1, a preferred embodiment of invention 10 may include a utility, system or software 20 that may provide a digital display or dashboard 30 which may provide desired information and may be real-time. System 20 may connect or communicate with point of sale terminals 40, vault terminal 50, ATMs 60, soft-count cash counters 70 and so forth with a real-time interface. System 20 may also connect or communicate with central server 80 wherein central server 80 may display and analyze cash information. Central server 80 may also connect or communicate with table games software 90, slot accounting software 100, cashier software 110, player's club software 120 and so forth.

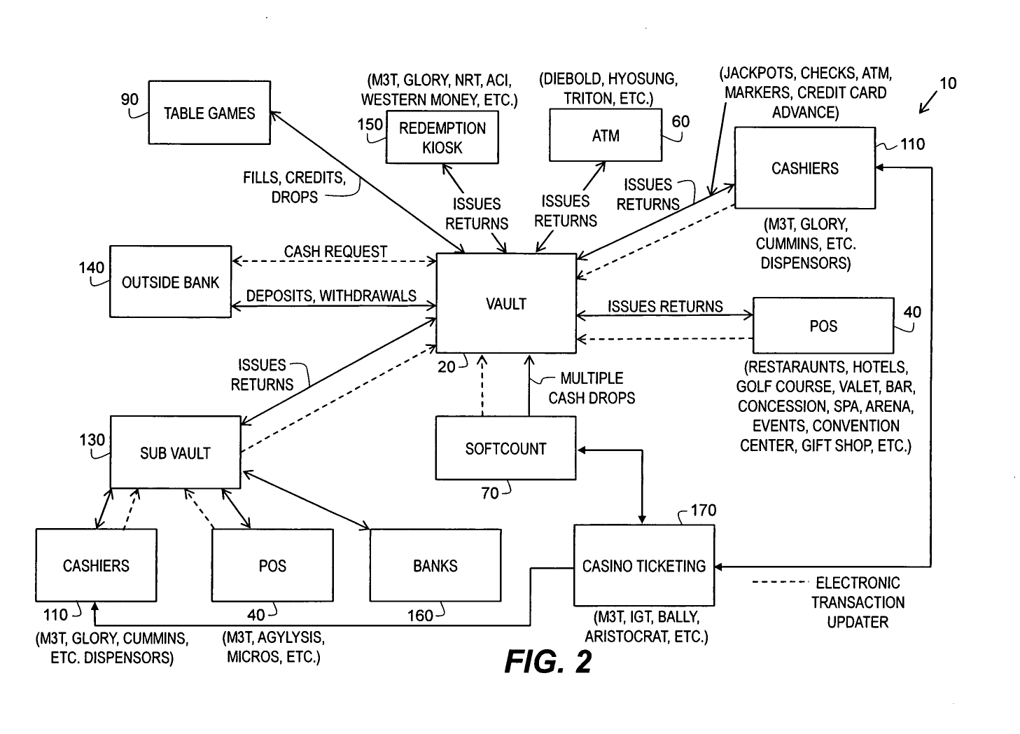

Once again referring to the illustration in general and more in particular to FIG. 2, invention 10 may include a sub vault or sub system 130 in communication with system 20 and wherein communication may be with cashiers 110, point of sale terminals 40, or other internal or external point of sale terminals, banks 160, internal and or external, combinations thereof and so forth. System 20 may be in communication with a soft count 70 which may also be in communication with casino ticketing 170 which may also be in communication with cashiers 110.

It is further contemplated that banks 160 may be internal or outside 140 and be in communication with system 20. Still furthermore, system 20 may be in communication with redemption kiosks 150.

The current invention provides a single cash management solution for integrated casino resort operations. The invention may utilize or work in association with commercial, off-the-shelf (COTS) server platforms, such as the IBM BladeCenter® family or equivalent, in a fully integrated, easy to manage and deploy solution. Instead of the typical, often time-intensive mix-and-match software and hardware approach, the current invention provides casino resort operators an entirely integrated casino management solution in a simple, easy-to-implement and managed package, resulting in a faster deployment and realization of value. The invention marries the benefits of IBM's industry-leading x86, Blade and Power server technology with Datatrend's unmatched integration, deployment and implementation experience to offer a simple yet scalable, completely integrated and cost-effective cash management solution.

With the invention, operators can save money and view their properties in an entirely new light. The invention can be installed in one day for a 100 slot machine facility with three interfaces, and in up to eight weeks for a 2,000 slot machine facility with 20 interfaces and may include a powerful deposit estimator with configurable reporting features that guide casino resorts through crucial management decisions. Through the inclusion of an analytics system, such as but not limited to Smartware™ analytics by M3T, the invention may also minimizes idle cash inventory, freeing these funds for other uses and or allowing these funds to gain vital interest income and may include a powerful deposit estimator with configurable reporting features that guide casino resorts through crucial management decisions. The invention may also provide transaction tracking, tip tracking and ticket imaging.

In a preferred construction, the invention may be scalable to meet the needs of the largest multi-site operations and allow real-time cash management system over numerous locations and sites. The invention may feature SAS-S2S ticket server technology, integrated slot and table accounting, and advanced features such as data mining, marketing campaign management and integrated financial services.

### Reporting

In a preferred embodiment, the present invention may provide operators with easily accessible real-time cash flow figures for all vaults, sub vaults, banks, mini-banks, POS stations (cashiers, restaurants, gift shops etc.), ticket redemption kiosks, and ATM's for casino resorts with numerous locations around the world. The invention minimizes idle cash inventory, accelerating resorts' ability to access funds and allowing these funds to gain vital interest income. The real-time tracking of the POS cash is enabled through transactional integration with POS systems, such as M3T POS, Agylysis, Micros, or equivalent systems. The “real-time” cashier is enabled by transactional integration of the cashier terminal to a cash dispenser such as M3T, Glory, Cummins, or equivalent cash dispensers. Each detailed transaction can be reviewed or audited and the “real-time” amount of cash by denomination is shown for each individual computer station and in aggregate for the entire location or enterprise.

### Dashboard

In a preferred embodiment, the present invention may provide a customized view of cash position and detailed transactions for management. The information will include custom algorithms and calculations presented in graphical and tabular format, allowing the manager to easily make decisions on the proper impress level for each function, the working capital requirement for the entire enterprise, and move personnel to improve customer service levels. It is contemplated that the dashboard system may be displayed on a computer screen, smart phone, digital service and so forth in real time. Smartware™ is a product by M3T that provides statistical calculations and algorithms integrated into the dashboard. It is further contemplated to provide a view and or access to analytic systems or software such as but not limited to Smartware™ by M3T on the dashboard specifically and in general.

The analytics system or analytics engine which may be displayed may include money and chip issues as well as money and chip return and may include by example check issue, check cash, marker funding/repayment, bank issue/return by person/station, chip fill/return by table, soft count cash drop such as but not limited to from casino slots, and combinations thereof.

The analytics system or engine may include calculation or data such as but not limited to mean usage by denomination by station/vault, standard deviation by denomination by station/vault, algorithm inclusion of weekday/weekend/holiday/promotion(s)/shift, etc., time between transaction, transaction per hour, and combination thereof.

This analytics system or engine may then feed to a dashboard for a user and may also feed to an analytic module that may create information and recommendations such as but not limited to set vault impress levels, working capital adjustments, money requirement forecast, and combinations thereof.

### Impress Module

The impress module may provide the software tools and or systems, predictive calculation and algorithms, for the purpose of setting an impress for each transactional computer station that requires cash. The predictive impress level for function may be tracked specifically for factors such as station, station type, location, shift, day of the week, and or holiday. Further factors may be special events such as promotions and or multiple promotions. Still also may be time frame, such as but not limited to week, month, selected set day average such as but not limited to 10 days, 20 days, 50 days etc., life to date, and so forth. It is further contemplated to provide a view and or access to analytic systems or software such as but not limited to Smartware™ by M3T.

### Ticket Imaging

Also in a preferred embodiment, the present invention may allow cashiers to quickly image a whole shift's worth of tickets, validate the amount of tickets and determine whether or not they have been redeemed. Ticket images are permanently stored in a database, removing the need to store and search for cumbersome amounts of paper tickets, which last only several months and cause numerous auditing issues.

### Quick Count and Quick Drawers

In accordance with a preferred embodiment, the present invention may provide custom money-bundling features, along with quick count drawers, allow vaults to be efficiently opened and closed. The invention creates an entire batch of drawers for the cage, tables and player services while maintaining the integrity of vault accounting. Cash and coin that is part of the vault total but sitting ready for disbursement may be tracked down to the penny.

### Deposit Estimator

Still in accordance with a preferred embodiment, the invention may identify trends and provide a complete picture of the needed cash position by using historical data to identify trends and give a full picture of the needed cash position. On-demand reports detail which denominations need to be deposited and which need to be replenished in a vault. It may also have easily accessible settings that allow managers to maintain the proper mix of cash and coin.

### Transaction by Denomination

In a preferred embodiment, the present invention may provide management a real-time view of all money in and out of the vault—by denomination—and includes tickets and chips, as well as reports of all cash—also by denomination—that lies idle in POS terminals, ATM's, etc.

### Bankroll Increases and Exchanges

Currently, cashiers must request money transfers over the phone, wait for a security guard to deliver the funds, and then complete the required paperwork. The current invention slashes the time spent completing this process, allowing casinos to alter funds in POS terminals and constantly account for money moving around the property, with a documented audit trail when needed.

### Variance Correction

Left unchecked, a variance in the vault leads to inaccurate records of cash on hand and opens the door for fraud. In a preferred embodiment, the invention may show variances in opening and closing numbers accounted for daily and can be more quickly addressed by the system user.

### Manage Tips

Resorts allow employees to place tips in the vault for safekeeping, but tips must be manually tracked, creating a time-consuming and frustrating process for both vault personnel and employees. In accordance with a preferred embodiment, the invention helps manage all tips collected on the floor and through casino services, with features like tax deductions for the IRS and flexible settings to allow tips to be distributed based on departments.

### Operation Systems

In a preferred embodiment, the invention may generally utilize a computer system. The system may include various input/output (I/O) devices (e.g., mouse, keyboard, display, Internet-enabled mobile phone, and Internet-enabled PDA) and one or more general purpose computers having a central processor unit (CPU), an I/O unit and a memory that stores data and various programs such as an operating system, and one or more authoring applications (e.g., programs for word processing, creating spread sheets, and producing graphics), one or more client applications (e.g., programs for accessing online services), and one or more browser applications (e.g., programs for retrieving and viewing electronic documents from the Internet and/or Web). The computer system may also include a communications device (e.g., a satellite receiver, a modem, or network adapter) for exchanging data with a host through a communications link (e.g., a telephone line and/or a wireless link) and/or a network.

It is contemplated that the invention may be activated, accessed, utilized and so forth by the use of a computer screen related desktop icon for instantaneous retrieval. It is understood that in a preferred embodiment, the icon will be located in a lower location such as but not limited to a tool bar commonly associated at the bottom right of a computer screen. The invention may be accessed by other means and the icon use should not be considered limiting the scope of the invention. The invention may be utilized with any and all types of internet communication portals. Further, the invention should not be considered limited to existing systems and that the invention may be utilized with other types of internet communication portals.

Likewise, it is contemplated that the invention may be utilized in other means other than a personal computer screen application. It may be utilized with hand held devices, cellular phones, PDAs, and car computer systems or displays. It also includes devices that are mobile, devices that are stationary and or devices that are a combination of mobile and or stationary. It is further contemplated that the invention may be utilized with public phones that may include a visual screen or display to replace or enhance existing phone booths. Likewise, free standing kiosks, booths or other locations may be specifically established to provide a display and access to the invention and said invention may include such established physical access ports, places, kiosks, and the like.

It is still contemplated that the invention may include, utilize, be selectively accessed by specified groups or sub groups, such as a designated entity like a business, center, city and so forth. It is contemplated that the invention may include specific promotional materials that companies have produced and would pay the manufacturer or business to appear online with the business that is listed or has an ad or web site. This would include any and all types of information including local, regional, national, international and worldwide. It can be placed permanently or temporarily including web sites, ads, commercials and any and all type of promotions, advertising, informational and communication data and not excluding any other form or type of knowledge.

### IBM BladeCenter

It is contemplated that the current invention may be pre-integrated before it reaches the user's site wherein the user can generally open the box, plug it in and configure it. The hardware and software are compatible and optimized. Users may be able to order the invention installed on a variety of IBM BladeCenter platforms designed to meet specific business requirements.

In a preferred construction, the invention may utilize an IBM BladeCenter platform that utilizes an advanced blade system that integrates servers, storage and network-attached devices into a single chassis—for a simplified, dense solution that lowers the total cost of ownership. A single family of common server blades, storage, I/O, switches and networking modules are fully supported and interchangeable across the entire BladeCenter chassis family. As a result, independent software vendors and system integrators can develop leading-edge solutions, choosing the appropriate chassis for deployment based on clients' needs.

IBM BladeCenter may be tailored to different applications, environments and performance requirements. With several choices of chassis, including the appropriate choice for data centers, distributed environments, branch offices and nontraditional environments, the invention may provide for tailored needs. With IBM BladeCenter, blade servers and switch modules can be seamlessly moved between chassis, giving you maximum flexibility and mix and match deployment choices.

The IBM BladeCenter family also supports an interchangeable family of blade servers. For example, the IBM BladeCenter HS22 is a versatile, easy to use blade optimized for performance, power and cooling—ideal for most enterprise applications including virtualization, hosted client and business applications. The IBM BladeCenter HS12 is a cost-efficient uniprocessor blade for general business applications such as file and print, collaboration and Web serving.

It is also contemplated that the current invention may utilize the IBM BladeCenter H which is a high-performance, high-density chassis ideal for even the most demanding applications. Furthermore, it is contemplated to utilize the IBM BladeCenter E which is an energy-efficient, high-density chassis and generally ideal for space and power constrained data centers. Still furthermore, it is contemplated to utilize the IBM BladeCenter S which is generally an all-in-one chassis with integrated, high-performance SAN and ideal for small offices and remote branch environments.

Changes may be made in the combinations, operations, and arrangements of the various parts and elements described herein without departing from the spirit and scope of the invention. Furthermore, names, titles, headings and general division of the aforementioned are provided for convenience and should, therefore, not be considered limiting.

I claim:

1. A cash management computer system with a central server for casinos that displays and analyzes cash information comprising:
at least one point of sale terminal in communication with said server;
at least one vault terminal in communication with said server; and
at least one soft cash counter in communication with said server.

2. The cash management system of claim 1 further including table games software system in communication with said server.

3. The cash management system of claim 2 further including slot accounting software system in communication with said server.

4. The cash management system of claim 3 further including cashier software system in communication with said server.

5. The cash management system of claim 4 further including player's club software system in communication with said server.

6. A method for cash management for casinos comprising:
providing information regarding issue, cash on hand, marker funding and repayment, bank issue and return by station, chip fill and return by table, and soft count cash drop;
analyzing said information; and
displaying said information.

7. The method of claim 7 wherein the step of analyzing said information further includes calculating mean usage by denomination by station.

8. The method of claim 8 wherein the step of analyzing said information further includes calculating standard deviation by denomination by station.

9. The method of claim 8 wherein the step of analyzing said information further includes algorithm inclusion of a time period.

10. The method of claim 9 wherein the step of analyzing said information further includes calculating time between transaction.

11. The method of claim 10 wherein the step of analyzing said information further includes calculating transaction per hour

12. The method of claim 11 wherein the step of analyzing said information further includes setting vault impress levels.

13. The method of claim 11 wherein the step of analyzing said information further includes setting vault impress levels with predictive calculations.

14. The method of claim 12 wherein the step of analyzing said information further includes adjusting working capital.

15. The method of claim 13 wherein the step of analyzing said information further includes forecasting money requirements.
